(19) United States
(12) Patent Application Publication
(10) Pub. No.: US 2004/0004744 A1
(43) Pub. Date: Jan. 8, 2004

(54) Apparatus and method for obtaining image information from an image original

(76) Inventors: Peter Haider, Geltendorf (DE); Bernhard Lorenz, Marzling (DE); Wolfgang Ruf, Muenchen (DE); Hans-Georg Schindler, Holzkirchen (DE); Tobias Epple, Taufkirchen (DE)

Correspondence Address: Karl F. Milde, Jr., Esq., MILDE & HOFFBERG, L.L.P., Suite 460, 10 Bank Street, White Plains, NY, 10606, US

(21) Appl. No.: 10/448,497

(22) Filed: May 29, 2003

(30) Foreign Application Priority Data
Jul. 2, 2002 (EP) 02014626.2

(51) Int. Cl. H04N 1/48

(52) U.S. Cl. 358/509; 358/506; 358/511

(57) ABSTRACT

An apparatus and a method for obtaining image information of an image original, such as a photographic negative, are disclosed. Light for exposing the image original (5) is emitted by a light source (10). Light that has been used to expose the image original (5) is subsequently detected by a light detector (28-30). In this case, obtaining the image information of the image original (5) is controlled by a control unit (31). The control unit (31) determines a certain point in time (T2-T4, T8-T10) corresponding to a parameter that has been determined earlier and that is specific to the image original (5). The light detector (28-30) is triggered at certain points in time (T2-T4, T8-T10) by the control unit (31) for obtaining the image information of the image original (5).

### BACKGROUND OF THE INVENTION

The present invention relates to a method and apparatus for painting image information from an image original, such as a photographic negative or a photographic positive image. This method and apparatus employs light source for emitting light to expose the image original and a light detector for detecting light that has been exposed to the image original for obtaining the image information from the image original.

Such an apparatus and method are known from the European Patent Application No. EP 0 691 568 A1. This patent application describes a photographic film scanner, which can be used to obtain image information from image originals. The film is illuminated using a light source. A detector collects the light that passes through the film. The image information of the individual images of the film, acquired by the detector, is used to determine characteristic properties of the respective image such as the maximum and minimum density, for example. These determined properties of the individual images of the film are then used for exposure control in a subsequent exposure process, where the respective image of the film is exposed onto photographic paper. The detector has a certain dynamic range, within which it is capable of taking the image information of the image in an undistorted fashion. Thus, according to EP 0 691 568 A1, the detector must be operated such that this dynamic range is not violated. To this end, it is necessary not to allow the amount of light that is collected by the detector to violate a certain maximum limit value. This is accomplished by a respective control of the light source. The light source contains numerous light emitting diodes that are controlled correspondingly. Light intensity and duration of the individual LEDs are set in accordance with the specification of the dynamic range of the detector. The spectral density distribution of the respective image on the film can be used to set the intensity and the duration of the illumination of the individual LEDs.

A device and a method for obtaining image information from an image original are also known from the published Patent Application No. WO 97/02698. According to this patent application, a calibration of the known device is performed. Light intensity fluctuations of light emitting diodes, which are used as a light source for exposing the image original, and sensitivity fluctuations of the photo detectors which obtain the light reflected by the image original are compensated. To compensate for the light intensity and sensitivity fluctuations, first a coarse adjustment is made, with which the power of the light emitting diodes of the light source and the duration during which the light emitting diodes emit light, are varied. To determine the controls necessary for the compensation for setting the power of the light emitting diodes and the illumination duration, test strips of dark and light gray are obtained. Correction settings are computed from the comparison of the image information obtained through these test exposures with nominal values. During a second step, a fine adjustment is carried out, where for each element of the photo detector, previously stored correction values are used when obtaining the image information of the respective image original. These correction values are also acquired through compensation tests performed earlier. Alternatively, the receiving time of the individual photo detector elements can be varied instead of varying the illumination duration of the light emitting diode for compensating the light intensity and sensitivity fluctuations.

### SUMMARY OF THE INVENTION

It is a primary objective of the present invention to specify an apparatus and method for obtaining image information from an image original in such a manner to ensure that the image information is obtained reliably and in a technically simple manner.

This objective, as well as other objectives which will become apparent from the discussion that follows, are achieved, in accordance with the present invention, by determining a certain point in time, corresponding to a parameter that has been determined earlier, that is specific to the image original, and triggering the light detector to obtain the image information from the image original at this certain point in time. This function is carried out by a control unit associated with the apparatus.

According to the invention a parameter that has been determined earlier and that is specific for the respective image original is used by the control unit to determine a certain point in time. This point in time is used by the control unit to control the light detector in order to obtain the image information of the respective image original. Thus, certain properties of the respective image original can be used to control the light detector corresponding to these properties of the image original in order to obtain the image information. In this way, an override of the light detector can be implemented in a particularly simple manner independent of the control of the light source.

In an advantageous embodiment of the invention, the device contains a means for scanning that can be used to scan the image original. Certain properties of the image original can be determined using the scanning means. In addition, the control unit is designed such that it determines the parameter that is specific for the image original using these determined properties of the image original. This allows for a simple specification of the parameter.

In an additional advantageous embodiment of the invention, a minimum density of the image original is allocated to the parameter that is specific to the image original. In this manner, it is possible to ensure optimum protection of the light detector from overcontrol, especially when the image original is a photographic negative. In particular, the minimum density can be determined using the scanning means.

In one particularly advantageous embodiment of the invention, the light source is designed such that the light is able to emit several colors. In this manner, it is possible to obtain the image information from an especially large number of image originals, in particular in comparison to a sequential output of several colors by the light source.

Furthermore, it is advantageous to provide several light detectors, which can detect several colors, in the device subject to the invention. In particular, these several light detectors can be designed in a plane in order to be able to detect light that is used to expose a plane image original. To this end, the light detectors are advantageously designed and arranged such that each light detector detects the light of one single color, which has been used to expose the image original. In this manner, it is advantageously possible to enable parallel, simultaneous detection of the image information in various colors. This can ensure a high speed when obtaining image information and at the same time equal spectral light distribution for illuminating the image original.

It is advantageous for the control unit to determine parameters for several colors, where said parameters are specific for the image original in the several colors. Determining these parameters can occur based on properties from the image original that have been determined by the scanning means. In particular the respective lowest densities of the image original in the several colors are allocated to these parameters that are specific to the image original and the color. In this manner, it is possible to ensure an even better optimized protection from overcontrol for the light detector, which is capable of detecting light of several colors.

In a particularly advantageous embodiment of the invention, the light source is activated corresponding to the highest of the respective lowest densities from the image original. The lowest densities of the other colors are then not used for controlling the light source. Thus, a simple control of the light source as well as a dependable and accurate exposure of the image original and the obtaining of the images information is possible.

It is advantageous if the output of light by the light source is finished when the light detectors are beginning to be controlled by the control unit for the purpose of the continued processing, in particular for the reading of obtained image information. In this manner, it can be ensured that only such light is detected that indeed serves the purpose of obtaining the image information from the image original. Also for simplification purposes, light detectors can be used that continue to detect light when reading the image information if light strikes them.

A particularly simple control of the light source to end the output of light can be accomplished when the output of the light for several colors finishes at the same time. Advantageously, the light source is, therefore, controlled by the control unit in a corresponding manner.

When obtaining the image information of several image originals sequentially, it is particularly advantageous to re-specify the respective light duration of the light source for the output of light from one image original to the next. Thus, an optimal illumination duration can be specified for each individual image original based on the previously determined parameters. In this manner, the image information of several image originals can be obtained optimally while keeping a high acquisition rate. This is particularly true in comparison to constant illumination durations when obtaining the image information of several image originals. At the same time, the overcontrol of the light detectors can be avoided. The illumination duration of the light source for the several colors can advantageously remain the same for the respective image originals. Thus, a simple control of the light source is still ensured.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a block diagram of a preferred embodiment of a device, according to the present invention, for obtaining the image information from an image original.

FIG. 2 is a time chart for the control of the light source and of the light detector in the device of FIG. 1.

### DESCRIPTION OF THE PREFERRED EMBODIMENTS

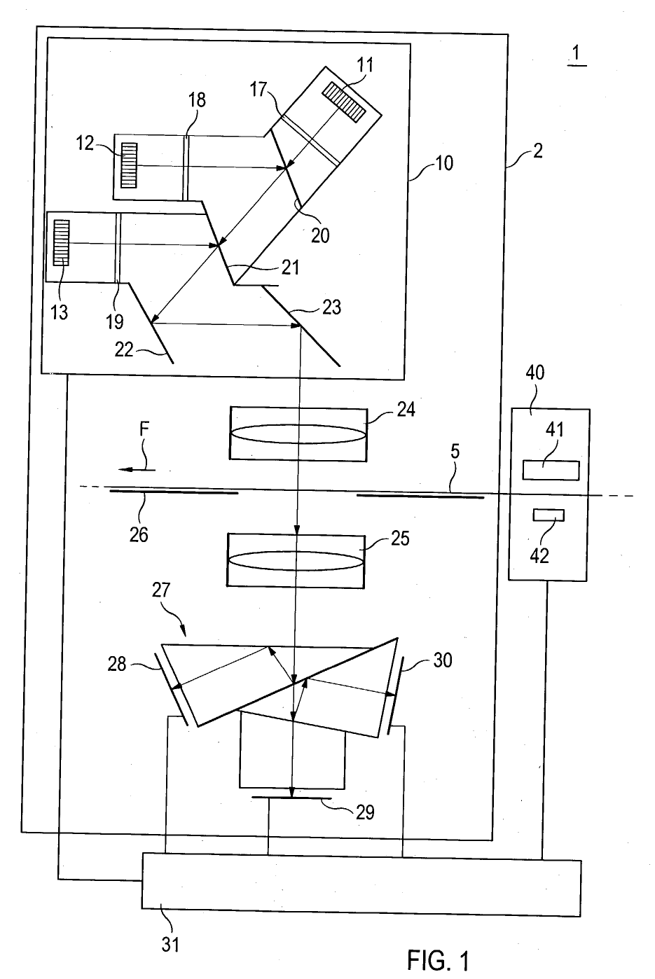

FIG. 1 shows the preferred embodiment of a device 1 according to the invention for obtaining image information from image originals. This device incorporates a scanner 2 for scanning photographic film 5. In this case, the film is a series of numerous filmstrips that contain several images adjacent to one another and developed in the film. For example, the photographic film may be a 35 mm negative film.

The device 1 contains a main scanner 2 that can be used to make high-resolution scans of the individual image originals from the photographic film. In addition, the device 1 includes a prescanner 40 that can be used for low-resolution scanning of the individual image originals from the photographic film. The photographic film is transported through the prescanner 40 and the main scanner 2 in a film advance direction F by transport means (not shown). Viewed in the film advance direction, the prescanner 40 is located before the main scanner 2. In the prescanner 40, the film 5 is illuminated by a light source 41, and a respective line-shaped section of the film 5 is reproduced on sensor cells of the light detector 42. In the present preferred embodiment, the light source 41 contains numerous light emitting diodes that emit light in the primary colors blue, green and red. Accordingly, a blue, green and red color separation of each line of the scanned film 5 is reproduced on the sensor cells of the light detector 42. By scanning the photographic film 5 with the prescanner 40, among other things, the image position of the image originals on the photographic film 5, as well as other film and image original specific data, can be determined.

Using these data, parameters can then be specified for the main scanner as well as for digital signal processing. To process the parameters determined by the prescanner 40, the prescanner 40 is connected to a control unit 31. The data that is determined is transmitted from the prescanner 40 to the control unit 31. To decouple the prescanner 40 from the main scanner 2, a film loop can be provided between the prescanner 40 and the main scanner 2; for simplicity sake, this film loop is not shown in the present embodiment.

The main scanner 2 contains a light source 10 for emitting multi-colored light. For example, the light source 10 can emit white light. To this end, it may in particular contain white light emitting diodes or a halogen lamp. For the purposes of the present invention, especially the halogen lamp can be used advantageously in connection with a mechanical shutter. Here, the light source 10 emits light in the primary colors blue, green and red. For this purpose, it includes a first LED array 11 with numerous blue LEDs, a second LED array 12 with numerous green LEDs and a third LED array 13 with numerous red LEDs. The blue light radiation emitted by the first LED array 11 is transmitted to a first filter 17, which absorbs certain spectral ranges of the light that do not belong to the required blue spectral range. The green light emitted by the second LED array 12 is transmitted to a second filter 18, which absorbs certain wavelength ranges that do not belong to the required green wavelength range. The red light radiation emitted by the third LED array 13 is transmitted to a third filter 19, which absorbs certain wavelength ranges that do not belong to the required red wavelength range. The light radiation that passes through the first filter 17 then strikes a first dichroic beam combiner 20, which combines the blue light radiation with the green light radiation that passes through the second filter 18 and that is also directed at the first dichroic beam combiner. The combined blue and green light radiation is then transmitted to a second dichroic beam combiner 21, which combines the combined blue and green light radiation with the red light radiation that passes through the third filter 19 and that is also directed at the second dichroic beam combiner. The fully combined, multi-colored light in the colors red, green and blue is then guided from a first reflector 22 to a second reflector 23, and is emitted from the light source 10 by the second reflector 23. The control unit 31 is connected to the light source 10 in order to control the light emission.

The light emitted by the light source 10 is guided via a condenser objective 24 to the image original of the photographic film 5 that is to be scanned. For this purpose, the photographic film 5 is guided across a film carrier 26. The light that passes through the image original to be scanned is guided to an imaging objective 25 and thereafter to a prism optics 27. The prism optics 27 splits the light guided to it into the color components of the three primary colors red, green and blue. The blue color component of the light is redirected by the prism optics 27 to a first CCD array 28, the green color component of the light to a second CCD array 29 and the red color component of the light to a third CCD array 30. The three CCD arrays 28, 29, 30 represent a light detector for detecting light that has been used to expose the image original. Using the three CCD arrays 28, 29, 30, the image information that is contained in the scanned image original is obtained at a high-resolution. The three CCD arrays 28, 29, 30 are connected with the control unit 31 and transfer to it the image data obtained by said CCD arrays.

Three LED arrays and three CCD arrays for emitting and obtaining light in the three primary colors red, green and blue are present in this preferred embodiment. It is also possible to provide additional color channels for obtaining the image information of the image original in the main scanner 2. This may be an additional color channel for infrared (IR) light. To this end, an additional LED array that emits light in the infrared spectral range may be provided in the light source 10. The light detector then contains an additional CCD array that is used to detect the infrared light that passes through the image original. Using such an infrared color channel, damages to the image original, such as scratches can be, for example, recognized and used when obtaining the image information of the image original.

The present invention relates to controlling the light source 10 and the CCD arrays 28, 29 and 30 through the control unit 31. The control unit 31 is designed such that it uses image original specific parameters that have been determined for this control during the prescanning of the image original with the prescanner 40. When scanning photographic negatives, as is the case in the present embodiment, such image original specific parameters are in particular the minimum densities of the image original in the three primary colors red, green and blue. These minimum densities are determined by the control unit 31 based on the prescan values of the image original as determined by the prescanner 40. The minimum densities in the three primary colors red, green and blue indicate those densities of the film negative to be scanned that are attributed to areas of the film negative, which - based on the respective primary color - have been exposed the least. This means that at these locations, the film negative is—based on the respective primary color—the least darkened. The minimal densities are, therefore, relevant for avoiding overcontrolling of the respective CCD arrays 28, 29, 30. When exposing the film negative with the light source 10, the most light passes through the locations with the least densities. Obtaining image information from the negative is, therefore, advantageously geared toward the minimum densities.

In the present preferred embodiment, controlling the light source 10 is carried out by the control unit 31 in the same manner for each of the respective LED arrays 11, 12 and 13. That is, the three LED arrays 11, 12, 13 begin and end their light emission at the same point in time. The duration of the light emission by the light source 10 is individually determined by the control unit 31 for the film negative to be scanned. Control of the CCD arrays 28, 29 and 30 by the control unit 31 is carried out based on the earlier determined minimum densities of the three primary colors red, green and blue. Based on these minimum densities, i.e., lowest densities, the control unit 31 controls the CCD array 28, 29, 30 using a reset pulse for starting the detection of light that has been used for scanning the film negative. After receiving such a reset pulse, the memories of the CCD array are set to zero, i.e., they are emptied, such that the amount of light received subsequently by the CCD array can be correlated with the film negative to be scanned.

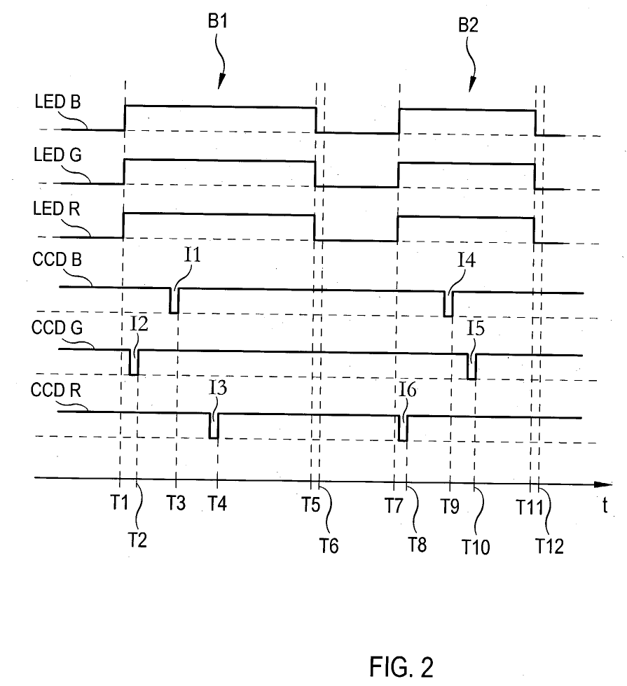

For clarification purposes, FIG. 2 shows a time chart of a control of the three LED arrays of the light source 10 and the three CCD arrays 28, 29 and 30 of the device 1 according to the preferred embodiment of FIG. 1. FIG. 2 shows control signals that are generated by the control unit 31 and that are used for controlling the LED arrays and the CCD arrays. FIG. 2 shows the control signals for scanning a first image B1 and a second image B2 that are located on the film 5. The control signal for the blue LED array 11 is designated with LED B in FIG. 2. The control signal for the green LED array 12 is designated with LED G in FIG. 2. The control signal for the red LED array 13 is designated with LED R. In addition, the control signal for the blue CCD array 28 is designated with CCD B, the control signal for the green CCD array 29 with CCD G and the control signal for the red CCD array 30 with CCD R.

A time axis t is drawn in the horizontal (ordinate). Various points in time are charted in this time axis, where these points in time mark certain events that are explained below in greater detail. A control of the light source 10 by the control unit 31 is carried out at the time T1. The three LED arrays 11, 12 and 13 receive a signal to start the emission of light. At a second point in time T2, the CCD array 29 has received a reset pulse I2, setting the green CCD array 29 for obtaining the green portion of the film negative to be scanned to zero. Such a reset pulse is advantageous with the CCDs used here, because they detect light whenever light strikes their photosensitive surfaces. Immediately after the beginning of the light emission at the time T1, the CCD arrays 28, 29, 30 receive light that shall, however, initially not be used for obtaining the image information of the film negative to be scanned. Only light detected after receiving the reset pulse from the respective CCD array shall be used for obtaining the image information of the film negative to be scanned.

In the time chart according to FIG. 2, the blue CCD array 28 receives a reset pulse I1 at the point in time T3. Light received by the CCD array 28 starting at this time T3 is used for obtaining the image information of the film negative to be scanned. At a fourth point in time T4, the red CCD array 30 receives a reset pulse I3. The points in time T2, T3 and T4 have been specified by the control unit 31 based on previously determined minimum densities of the film negative to be scanned in the three primary colors red, green and blue. With the film negative B1, the density in the green color range is greater than the density in the blue color range. The density in the blue color range, in turn, is greater than the density in the red color range. Thus, the green CCD array 29 is the first one to receive a reset pulse I2 before the blue CCD array 28 receives its reset pulse I1 second, and thereafter the red CCD array 30 receives its reset pulse I3.

At the point in time T5, the light source 10 is again triggered by the control unit 31 to end the light emission by the three LED arrays 11, 12 and 13. After ending the light emission by the light source 10, no additional light strikes the three CCD arrays 28, 29 and 30, such that no additional image information of the film negative B1 can be obtained. The amount of light received by the blue CCD array 28 between the third point in time T3 and the fifth point in time T5 is, therefore allocated to the blue color component of the scanned film negative B1. The amount of light received by the green CCD array 29 between the point in time T2 and the point in time T5 is allocated to the green color component of the image information of the film negative B1 and the amount of light received by the red CCD array 30 between the point in time T4 and the point in time T5 is allocated to the red color component of the image information of the film negative B1. The three CCD arrays 28, 29, 30 are read at a sixth point in time T6. This means, the image data generated by the CCD arrays are transferred to the control unit 31. From these image data, the control unit 31 determines the high-resolution image information of the negative B1. This type of determining the image information based on image data transferred by CCD arrays is known and thus does not need further explanation here. The duration between the point in time T1 and the point in time T5, i.e., that duration during which the light source 10 emits light is specified by the control unit 30 corresponding to the highest i.e., the most dense, of the minimum densities of the negative B1. Advantageously, the light source 10 is switched on for scanning the respective image just prior to issuing—with regard to this respective image—the first reset pulse (in FIG. 2, the reset pulse I2). This ensures that the LED arrays of the light source 10 are lit only for a minimum required duration. This reduces the power loss of the light source 10 and ensures a minimum required scanning time when scanning the image.

Also shown in the time chart according to FIG. 2 are the control signals for the LED arrays 11, 12, 13 and the CCD arrays 28, 29, 30 for scanning the second image B2. After reading the image data allocated to the first image B1 from the CCD arrays 28, 29, 30, the main scanner 2 is ready for scanning the second image B2. This scanning is carried out with the control of the three LED arrays 11, 12, 13 at a seventh point in time T7. At this point in time T7, the light source 10 begins to emit the multi-colored light onto the film negative B2. At an eighth point in time T8, the red CCD array 30 has received from the control unit 31 a reset pulse I6 that is used to set the memories of the CCD array 30 to zero in order to start with the detection of light for obtaining the image information of the negative B2. At the ninth point in time T9, the blue CCD array 28 has received a reset pulse I4 and at the tenth point in time T10, the green CCD array 29 a reset pulse I5 for resetting its memory. In the present example, the reset pulse I6 is issued by the control unit 31 prior to the reset pulse I4, and the reset pulse I4, in turn, prior to the reset pulse I5. This means that the density of the negative B2 is greatest in the red color range. The density of the negative B2 is lowest in the green color range and the density of the negative B2 in the blue color range is between the densities in the red and green color ranges. At an eleventh point in time T11, the LED arrays 11, 12, 13 receive a pulse to end the light emission. Thus, from this point in time T11, the three CCD arrays 28, 29, 30 no longer detect light for obtaining the image information of the negative B2. At the twelfth point in time T12, the three CCD arrays 28, 29, 30 are read out. This means, they transfer the respective image data to the control unit 31. In this case also, the duration that the LED arrays 11, 12, 13 emit light is oriented on the highest, i.e., the most dense, minimum densities of the negative B2 in the three primary colors red, green and blue. The light source 10 is switched on at the point in time T7 just before the first reset pulse I6 is presented by the control unit 31.

In the present example, the duration for emitting light by the light source 10 for scanning the negative B2 is shorter than the duration for emitting light for scanning the negative B1. The reason for this is that the highest minimum density of the negative B2 is less than the highest minimum density of the negative B1. Compared to a constant duration of the illumination of the light source 10 when scanning various image originals, setting the various durations of illumination corresponding to image original specific parameters, in particular, the minimum densities of the respective image originals, has the advantage of enabling faster scanning of a multitude of image originals.

In the described preferred embodiment, photo negatives have been scanned, whereby the minimum densities of the respective negatives have been used for setting the points in time for obtaining the image information. Photographic negatives are scanned using a transillumination method, where the light source is located on one side of the negative and the light detector on the other side of the negative. However, image originals may also be such objects that reflect the scanning light directed at them. This can be, for example, a photographic paper image that is to be scanned. In this case, it is advantageous to use a maximum reflection of the light, which is reflected by the image original to be scanned, as the image original specific parameter.

This parameter of the maximum reflection of light can be determined through pre-scanning of the image original as well.

The control of the CCD array according to the invention, corresponding to the image original specific parameters, in particular of a minimum density of the negative, with at the same time a constant duration of illumination of the LEDs of the light source 10 in various colors, is especially advantageous because the spectral distribution of the light, which is directed at the respective negatives when obtaining the image information, is constant in each case. Consequently, the spectral distribution of the light that is used to illuminate the CCDs is always the same. This is particularly important because the spectral separation of the various colors of the light emitting diodes cannot be ensured unambiguously. The LEDs do not just emit light in the wavelength that is required within the wavelength range that is optimal for obtaining the image information. Rather, the LEDs also emit light in other, non-desirable wavelength ranges. Even if it is possible to use filters, such as the filters 17, 18 and 19, for example, which can be used to limit the wavelength range of the emission of the respective LED arrays 11, 12, 13, it is not possible to carry out an optimum border. These filters 17, 18, 19 cannot be too narrow in design because this would reduce too much the amount of light that is emitted by the light source. Not enough light would strike the respective negative and the light detector. When setting various illumination durations of the various color LED arrays corresponding to image original specific parameters, as is the case when scanning an image original according to the state-of-the-art, the illumination duration of the LEDs in the various colors varies from one image original to the next. The illumination duration when scanning an image original is not the same for all LEDs. In this manner, the spectral distribution of the light that is used to illuminate the CCDs is different from one image original to the next. This can lead to disadvantageous distortions when obtaining the image information of the image original.

There has thus been shown and described a novel apparatus and method for obtaining image information from an image original which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. Apparatus for obtaining image information from an image original, said apparatus comprising:
(a) a light source for emitting light for exposing the image original;
(b) a light detector for detecting light that has been exposed to the image original for obtaining the image information from the image original; and
(c) means for controlling the process of obtaining the image information from the image original, said control unit having means for determining a certain point in time, corresponding to a parameter that has been determined earlier, that is specific to the image original, and means responsive to said determining means, for controlling the light detector at said certain point in time to receive the image information.

2. The apparatus set forth in claim 1, wherein the control unit determines the certain point in time and controls the light detector such that the light detector begins detecting the light for obtaining the image information from the image original at said certain point in time.

3. The apparatus set forth in claim 1, further comprising scanning means for scanning the image original and wherein the control unit determines said image original specific parameter in dependence upon properties of the image original as determined by the scanning means.

4. The apparatus set forth in claim 1, wherein said image original specific parameter is assigned to a lowest density of the image original.

5. The apparatus set forth in claim 1, wherein said light source emits light in several colors simultaneously.

6. The apparatus set forth in claim 5, wherein several light detectors are present for detecting the light of several colors and wherein each of the several light detectors is intended for detecting light of one single color.

7. The apparatus set forth in claim 6, further comprising light distribution means for color-selective distribution of the multi-colored light to the light detectors.

8. The apparatus set forth in claim 3, wherein the control unit determines parameters that are specific for the several colors of the image original using the properties of the image original as determined for the several colors by the scanning means.

9. The apparatus set forth in claim 8, wherein the image original specific and color specific parameters are allocated to the respective lowest densities of the image original in several colors.

10. The apparatus set forth in claim 9, wherein the control unit activates the light source to expose the image original corresponding to the highest of the respective lowest densities of the image original.

11. The apparatus set forth in claim 6, wherein the control unit triggers the light detectors, after the light emission has ended, to obtain from them the image information of the image original.

12. The apparatus set forth in claim 11, wherein the light source is connected to the control unit and wherein the control unit terminates the emission of light by the light source such that the time the image information of the image original is obtained ends simultaneously for the several colors.

13. The apparatus set forth in claim 12, wherein the control unit re-specifies the respective illumination duration of the light source from one image original (B1) to the next (B2) for emitting light when obtaining image information of several image originals.

14. A method for obtaining image information from an image original, said method comprising the steps of:
(a) exposing the image original with light emitted by a light source;
(b) detecting the light that has been exposed to the image original by means of a light detector;
(c) determining a certain point in time corresponding to a parameter that has been determined earlier and that is specific to the image original; and
(d) triggering the light detector at said certain point in time to receive the image information from the image original.
